(19) United States
(12) Patent Application Publication
(10) Pub. No.: US 2009/0004891 A1
(43) Pub. Date: Jan. 1, 2009

(54) TEST ACCESS FOR HIGH DENSITY INTERCONNECT BOARDS

(76) Inventors: James Grealish, Beaverton, OR (US); John T. Sprietsma, Portland, OR (US); William O. Alger, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/772,201

(22) Filed: Jun. 30, 2007

(51) Int. Cl. H01R 12/06

(52) U.S. Cl. 439/74

(57) ABSTRACT

A novel HDI board that enables test probe access comprises a stack of insulating layers having a first surface and a second surface, wherein the first surface includes at least two devices and the second surface includes a test probe accessible solder bead. The two devices are electrically coupled by at least one metal interconnect formed within the plurality of insulating layers. The HDI board also includes a backside μVia electrically coupling the solder bead to the metal interconnect. Testing of the device may be carried out by way of the solder bead and the backside μVia.

### BACKGROUND

High density interconnect (HDI) boards are multi-layer boards used to mount and interconnect devices such as integrated circuits. HDI boards are similar to conventional computer motherboards or printed circuit boards (PCB) but are generally used in different applications, such as mobile telephones and ultra mobile personal computers (UMPCs).

HDI boards typically have eight to ten layers. Electrical signals may be routed between devices mounted on the HDI board by way of conductive interconnects formed within these multiple layers. The conductive interconnects are generally comprised of metal interconnects and vias, where each via penetrates between layers to couple a metal interconnect from one layer to a metal interconnect from another layer. Unlike other devices, the vias used in HDI boards are much smaller in diameter and are referred to as micro-vias.

One problem encountered in the manufacture of HDI boards is limited test access. The metal interconnects and micro-vias used in the routing of signals through the internal layers of the HDI board cannot be probed to gain test access because they are typically located underneath Ball Grid Array parts. In addition, micro-vias generally cannot be probed directly due to their smaller geometry as via lands are typically 0.010″ or less.

Therefore, known techniques for testing HDI boards are Automated Optical Inspection and/or Automated X-Ray Inspection. These techniques, however, are not preferred over physically probing the electrical interconnects. Therefore, improved testing techniques are desired.

### BRIEF DESCRIPTION OF THE DRAWINGS

FIG. 1 is a cross-section of an HDI board constructed in accordance with an implementation of the invention.

### DETAILED DESCRIPTION

Described herein are systems and methods of probing electrical interconnects in an HDI board. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention provide a test probe accessible backside micro-via (μVia) that is used for test probing interlayer interconnects and/or interlayer μVias within a motherboard, such as an HDI board or a PCB. In implementations of the invention, one end of the backside μVia is coupled to the interlayer interconnect/via to be tested while the other end is routed to the “backside” of the HDI board, namely, a surface of the HDI board that is laterally opposite to a surface where devices such as integrated circuit chips are mounted. On this backside surface, the backside μVia terminates at a solder bead that is test probe accessible.

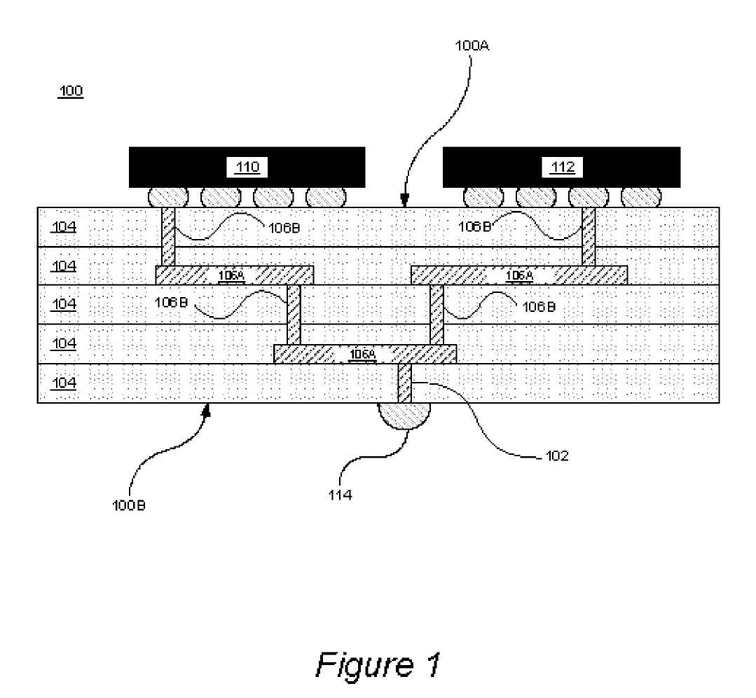

FIG. 1 illustrates a cross-section of an HDI board 100 that includes a backside μVia 102 in accordance with an implementation of the invention. The HDI board 100 is formed from multiple layers 104 and includes a first surface 100A and a second surface 100B. The multiple layers 104 may include conventional layers used in HDI boards, including but not limited to core layers, prepreg layers, and dielectric layers. The multiple layers 104 tend to be formed using insulating materials such as conventional dielectric materials, resins, glass reinforced epoxies, and non-reinforced epoxies.

At least one of the layers 104 includes one or more metal interconnects 106A. The metal interconnects 106A may be formed using a variety of metals, including but not limited to copper or aluminum. Often, copper foil or copper foil plated with copper metal is used. The diameter or thickness of the metal interconnects 106 is relatively small, often ranging from 0.001 inches to 0.010 inches. In the art, these metal interconnects 106A are also referred to as metal traces.

The HDI board 100 further includes a plurality of micro-Vias (μvia) 106B that are used to electrically couple the metal interconnects 106A, such as metal interconnects 106A located on different layers 104. The μVias 106B are typically formed from a metal such as copper or tungsten. Alternate metals well known in the art for vias or μVias may be used as well. Similar to the metal interconnects 106A, the diameter or thickness of the μVias 106B is relatively small, often ranging from 0.001 inches to 0.020 inches.

As shown in FIG. 1, a combination of metal interconnects 106A and μVias 106B may be used to electrically couple a first device 110 and a second device 112, thereby enabling the two devices to communicate using electrical signals that are routed internally within the HDI board 100. The first device 110 and the second device 112 are mounted to the first surface 100A of the HDI board 100 and may be any of a variety of devices conventionally used on HDI boards, including but not limited to integrated circuit devices or memory devices.

In accordance with implementations of the invention, a backside μVia 102 is included in the HDI board 100 to provide test access to a previously inaccessible internal metal interconnect 106A and/or μVia 106B. In an implementation of the invention, one end of the backside μVia 102 is electrically coupled to the desired internal metal interconnect 106A or μVia 106B. The other end of the backside μVia 102 is routed to the second surface 100B of the HDI board 100 where the backside μVia 102 is externally exposed.

Due to its extremely small diameter, the backside μVia 102 cannot be directly accessed by a test probe. Therefore, to facilitate the probing process, a solder bead 114 is formed on the exposed end of the backside μVia 102. The solder bead 114 is therefore mounted on the second surface 100B and enables a test probe to make sufficient electrical contact with the backside μVia 102 to enable testing. In implementations of the invention, the solder bead 114 may be formed using a lead-free solder.

The backside μVia 102 routes an electrical signal from an internal metal interconnect 106A or μVia 106B to the solder bead 114 to be test probed. In some implementations, as illustrated in FIG. 1, the backside μVia 102 consists of a sole μVia structure coupled between an internal metal interconnect 106A and the solder bead 114. In further implementations, the backside μVia 102 may include at least one μVia and at least one metal interconnect. In still further implementations, the backside μVia 102 may be coupled to a μVia 106B rather than a metal interconnect 106A.

Accordingly, implementations of the invention provide backside μVias, formed in HDI boards, to gain test access to previously inaccessible internal electrical signals. A desired electrical signal can be routed to a backside surface of the HDI board for the sole purpose of providing test access during high volume manufacturing of the HDI boards. Use of a solder bead on the end of the backside μVia enables conventional test probe methods to continue to be used, such as In-Circuit Tests (ICT) used for detecting structural faults in HDI board manufacturing.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. An HDI board comprising:
a first surface and a second surface, wherein the first surface is adapted for receiving a device;
a plurality of insulating layers;
at least one metal interconnect formed within the plurality of insulating layers;
a solder bead formed on the second surface, wherein the solder bead is test probe accessible; and
a backside μVia electrically coupling the solder bead to the metal interconnect.

2. The HDI board of claim 1, wherein the metal interconnect comprises copper or copper foil.

3. The HDI board of claim 1, wherein the backside μVia comprises copper or tungsten.

4. The HDI board of claim 1, wherein the metal interconnect has a thickness between around 0.001 inches and around 0.010 inches.

5. The HDI board of claim 1, wherein the backside μVia has a thickness between around 0.001 inches and around 0.020 inches.

6. The HDI board of claim 1, wherein at least one of the insulating layers comprises a conventional dielectric material, a resin, a glass reinforced epoxy, or a non-reinforced epoxy.

7. A substrate comprising:
a first insulating layer having a first surface;
a second insulating layer having a second surface;
a plurality of insulating layers sandwiched between the first insulating layer and the second insulating layer;
a first device and a second device mounted on the first surface;
a solder bead mounted on the second surface that is test probe accessible;
at least one metal interconnect formed within the plurality of insulating layers;
at least one μVia formed within the plurality of insulating layers, wherein the at least one metal interconnect and the at least one μVia are used for electrically coupling the first device to the second device; and
a backside μVia electrically coupling the at least one metal interconnect to the solder bead.

8. The substrate of claim 7, wherein the metal interconnect comprises copper or copper foil.

9. The substrate of claim 7, wherein the backside μVia comprises copper or tungsten.

10. The substrate of claim 7, wherein the metal interconnect has a thickness between around 0.001 inches and around 0.010 inches.

11. The substrate of claim 7, wherein the backside μVia has a thickness between around 0.001 inches and around 0.020 inches.

12. The substrate of claim 7, wherein at least one of the insulating layers comprises a conventional dielectric material, a resin, a glass reinforced epoxy, or a non-reinforced epoxy.

13. The substrate of claim 7, wherein the first device and the second device comprise integrated circuit chips.

14. The substrate of claim 7, wherein the backside μVia further comprises a metal interconnect.

15. The substrate of claim 7, wherein the substrate comprises an HDI board or a PCB.
